(19) United States
(12) Patent Application Publication
(10) Pub. No.: US 2006/0056867 A1
(43) Pub. Date: Mar. 16, 2006

(54) Image forming apparatus and adjustment method for image forming apparatus

(75) Inventor: Keiichi Taguchi, Nagano-ken (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/210,158

(22) Filed: Aug. 23, 2005

(30) Foreign Application Priority Data
Sep. 6, 2004 (JP) 2004-258071
Mar. 16, 2005 (JP) 2005-074692

(51) Int. Cl. G03G 15/00; G03G 15/01; G03G 15/06; G03G 15/043

(52) U.S. Cl. 399/49; 399/51; 399/55; 399/227

(57) ABSTRACT

Of developers 4a, 4b and 4d which are adjacent to each other on a rotary developing unit 4, the downstream-most developer 4d along the direction D4 of rotations of the rotary developing unit 4 is positioned first at a developing position and a patch image is formed. The rotary developing unit 4 then rotates 90 degrees, and the adjacent developer 4a is moved to the developing position. While the developer 4a forms a patch image, a memory of the developer 4b is updated. After this, while rotating the rotary developing unit 4 by 90 degrees each time, patch image formation with and memory update for the respective developers are carried out.

### CROSS REFERENCE TO RELATED APPLICATION

The disclosure of Japanese Patent Applications enumerated below including specification, drawings and claims is incorporated herein by reference in its entirety:

No. 2004-258071 filed on Sep. 6, 2004; and

No. 2005-074692 filed on Mar. 16, 2005.

### BACKGROUND OF THE INVENTION

1. Field of the Invention

The present invention relates to an image forming apparatus comprising a rotary developing unit which is capable of freely rotating in a predetermined direction and accepting a developer cartridge which is equipped with a memory unit, and relates also to an adjustment method of adjusting operation conditions for this apparatus.

2. Description of the Related Art

In the case of a conventional image forming apparatus comprising a rotary developing unit which accepts plural developer cartridges, an operation sequence is designed for a state that all cartridges which can be mounted are set at predetermined positions. However, in an effort to meet a wide spectrum of user demands, such an apparatus has been proposed recently which is capable of forming an image even when some developer cartridges are not set or the developer cartridges are mounted in a different arrangement from the originally intended arrangement.

The image forming apparatus described in Japanese Patent Application Laid-Open Gazette No. 2003-50495 for instance can print monochrome images when a developer cartridge for the monochrome color among four developer cartridges corresponding to four toner colors is mounted to the apparatus, regardless of whether the other cartridges are present. Meanwhile, the image forming apparatus described in Japanese Unexamined Patent Application Laid-Open Gazette No. 2002-351190 is capable of forming a monochrome image even when developer cartridges for the same colors are mounted to a rotary developing unit which is supposed to be set with developer cartridges for different toner colors.

In this type of image forming apparatus, for the purpose of properly managing the status of use of each developer cartridge, each developer cartridge may be equipped with a memory unit which stores information expressing the status of use of the developer cartridge, etc. An operation sequence for such an apparatus is designed so that information stored in the memory unit is updated after each developer cartridge has been used. However, in the event that the arrangement of the developer cartridges is irregular as described above, this operation sequence may not necessarily be optimal.

During adjustment of operation conditions for the apparatus which is executed when needed in accordance with each developer cartridge, since the time required for the adjustment influences the throughput of the apparatus, it is ideal that an optimal operation sequence is followed which is suitable to the arrangement of the developer cartridges at that time. However, such an operation sequence has not been examined in detail.

### SUMMARY OF THE INVENTION

The invention has been made in light of these problems, and aims at providing a proper adjustment operation sequence corresponding to the arrangement of developer cartridges in an image forming apparatus comprising a rotary developing unit.

In a first aspect of the invention which is directed to an image forming apparatus and an adjustment method for the same which comprises a rotary developing unit capable of freely rotating in a predetermined direction and accepting N (N is an integer equal to or larger than 3) developer cartridges, each of the developer cartridges comprising a memory unit storing information regarding status of use of the developer cartridge, for each one of M (M is an integer equal to or larger than 2 but smaller than N) developer cartridges which are mounted adjacent to each other to the rotary developing unit, the apparatus and the adjustment method execute: a patch image formation at which this developer cartridge is positioned at a predetermined developing position, and using this developer cartridge, a toner image which serves as a patch image is formed; an adjustment operation at which the density of the patch image is detected, and based on the result, an operation condition which will be applied to form a toner image using this developer cartridge is adjusted; and an update operation at which the memory unit disposed to this developer cartridge is accessed and the content of the memory unit is updated, wherein the patch image formation is executed while switching the developer cartridges in a direction from the downstream-most developer cartridge among the M developer cartridges toward the upstream-most developer cartridge along the direction of rotations of the rotary developing unit, and the update operation is executed on one developer cartridge which is on the downstream side and adjacent to other developer cartridge which is positioned at the developing position along the direction of rotations of the rotary developing unit.

According to the invention using such a structure, the amount by which the rotary developing unit must rotate is the minimum since the downstream-most developer cartridge along the direction of rotations of the rotary developing unit is positioned at the developing position and starts forming a patch image until the upstream-most developer cartridge gets positioned at the developing position. This attains switching of the developer cartridges in a short period of time. Further, since the developer cartridge which has finished forming a patch image is positioned at an access position and the next developer cartridge is positioned at the developing position at the same time as the rotary developing unit rotates a predetermined amount, it is possible to shorten the time required for the adjusting operation. One developer cartridge may form a patch image at certain desired timing and the update operation may be performed on other developer cartridge at other desired timing during a period in which the rotary developing unit remains at the same position.

In a second aspect of the invention which is directed to an image forming apparatus and an adjustment method for the same which comprises a rotary developing unit, which is capable of freely rotating in a predetermined direction and accepts three or more developer cartridges, each of the developer cartridges, each of developer cartridges comprising a memory unit which stores information regarding status of use of the developer cartridge, and which is capable of executing an image forming operation, during which a toner image is formed using a developer cartridge positioned at a predetermined developing position among developer cartridges which are mounted to the rotary developing unit, and an update operation during which the memory unit disposed to a developer cartridge positioned at a predetermined access position is accessed and the content of the memory unit is updated, the apparatus and the adjustment method execute: a formation of a toner image which serves as a patch image; and an adjusting operation to adjust an operation condition which will be applied for execution of the image forming operation based on the detected density of the patch image, wherein in the event that the adjusting operation needs be executed on two developer cartridges mounted to the rotary developing unit, when the two developer cartridges are positioned relative to each other such that the first developer cartridge out of the two developer cartridges which will be used first in the next image forming operation gets positioned at other position than the access position as the second developer cartridge out of the two developer cartridges comes to the developing position, the update operation is executed on the second developer cartridge after adjusting the operation condition, and on the first developer cartridge, the operation condition is adjusted without execution of the update operation.

In this invention, the update operation is not executed after execution of the adjusting operation for one developer cartridge, thereby reducing the number of times that the rotary developing unit must stop. This suppresses an increase of the processing time which will otherwise occur if the rotary developing unit must stop more times, and improves the throughput. Further, when the developer cartridge for which the update operation is omitted is determined to be the developer cartridge (first developer cartridge) which will be used first in the subsequent image forming operation, the update operation can be executed after this image forming operation, which gives rise to no problem in managing this cartridge.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a drawing which shows the structure of an image forming apparatus according to the present invention;

FIG. 2 is a block diagram of the electric structure of the image forming apparatus shown in FIG. 1;

FIGS. 3A and 3B are drawings which show stop positions for the rotary developing unit;

FIG. 4 is a drawing which shows an operation sequence for a full-color image forming operation;

FIG. 5 is a flow chart which shows the density controlling operation for where the developers are adjacent to each other;

FIG. 6 is a flow chart which shows the developing bias adjusting processing;

FIG. 7 is a flow chart which shows the exposure power adjusting processing;

FIG. 8 is a drawing which shows how the developing unit moves during the density controlling operation on three developers;

FIGS. 9 and 10 are drawings which show how the developing unit moves during the density controlling operation on two developers;

FIG. 11 is a drawing which shows a first example of a density controlling operation sequence on non-adjacent two developers;

FIG. 12 is a drawing which shows a second example of the density controlling operation sequence on non-adjacent two developers;

FIG. 13 is a drawing which shows a first example of the density controlling operation sequence on adjacent two developers;

FIG. 14 is a drawing which shows a second example of the density controlling operation sequence on adjacent two developers;

FIG. 15 is a drawing which shows a third example of the density controlling operation sequence on adjacent two developers;

FIG. 16 is a drawing which shows one example of the density controlling operation sequence on non-adjacent two developers;

FIG. 17 is a drawing which shows one example of the density controlling operation sequence on adjacent two developers; and

FIG. 18 is a flow chart of the density controlling operation sequence in this embodiment.

### DETAILED DESCRIPTION OF THE PREFERRED EMBODIMENTS

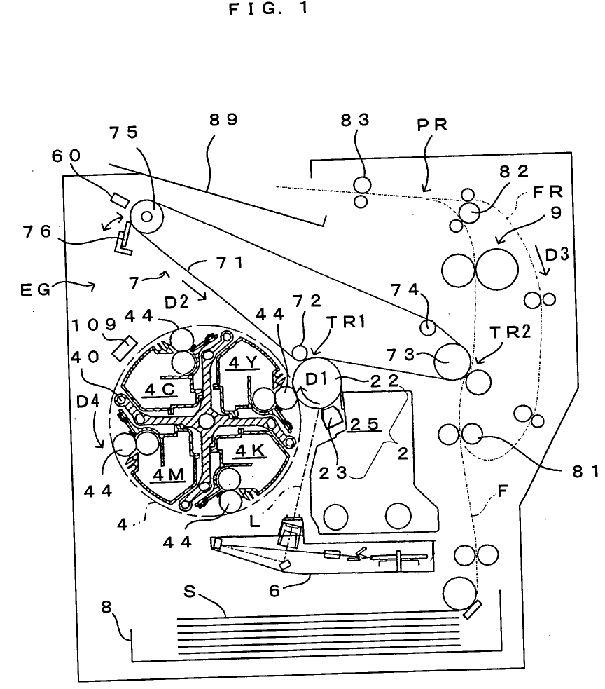

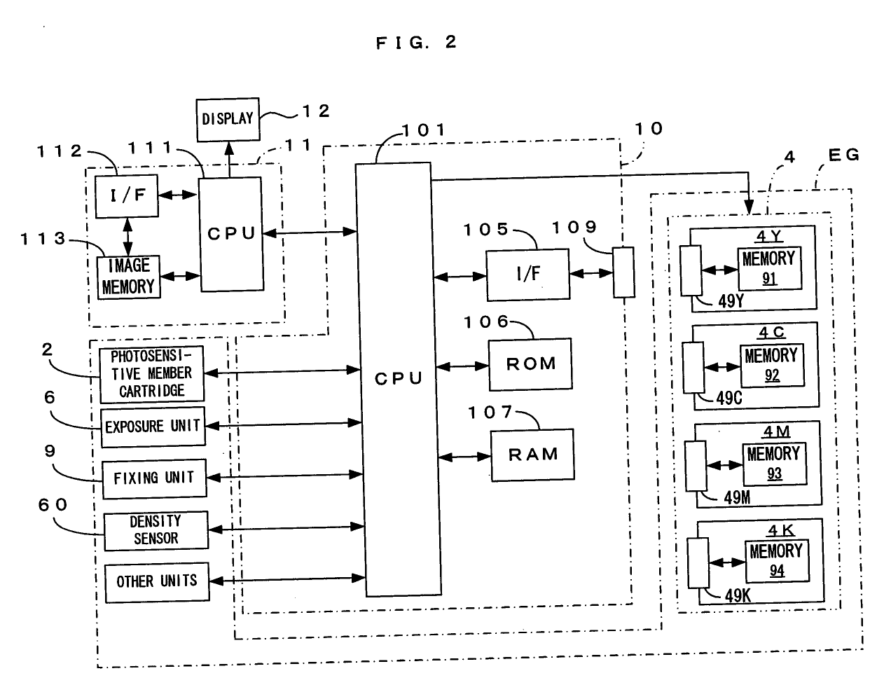

FIG. 1 is a drawing which shows the structure of an image forming apparatus according to the present invention. FIG. 2 is a block diagram of the electric structure of the image forming apparatus which is shown in FIG. 1. The illustrated apparatus is an apparatus which overlays toner in four colors of yellow (Y), cyan (C), magenta (M) and black (K) one atop the other and accordingly forms a full-color image, or forms a monochrome image using only black toner (K). In the image forming apparatus, when an image signal is fed to a main controller 11 from an external apparatus such as a host computer, a predetermined image forming operation is performed. That is, an engine controller 10 controls respective portions of an engine part EG in accordance with an instruction received from the main controller 11, and an image which corresponds to the image signal is formed on a sheet S.

In the engine part EG, a photosensitive member 22 is disposed so that the photosensitive member 22 can freely rotate in the arrow direction D1 shown in FIG. 1. Around the photosensitive member 22, a charger unit 23, a rotary developing unit 4 and a cleaner 25 are disposed in the rotation direction D1. A predetermined charging bias is applied upon the charger unit 23, whereby an outer circumferential surface of the photosensitive member 22 is charged uniformly to a predetermined surface potential. The cleaner 25 removes toner which remains adhering to the surface of the photosensitive member 22 after primary transfer, and collects the toner into a used toner tank which is disposed inside the cleaner 25. The photosensitive member 22, the charger unit 23 and the cleaner 25, integrated as one, form a photosensitive member cartridge 2. The photosensitive member cartridge 2 can be freely attached to and detached from a main section of the apparatus as one integrated unit.

An exposure unit 6 emits a light beam L toward the outer circumferential surface of the photosensitive member 22 which is thus charged by the charger unit 23. The exposure unit 6 makes the light beam L expose on the photosensitive member 22 in accordance with an image signal fed from the external apparatus and forms an electrostatic latent image which corresponds to the image signal.

The developing unit 4 develops thus formed electrostatic latent image with toner. The developing unit 4 comprises a support frame 40 which is disposed for free rotations about a rotation shaft which is perpendicular to the plane of FIG. 1, and also comprises a yellow developer 4Y, a cyan developer 4C, a magenta developer 4M and a black developer 4K which house toner of the respective colors and are formed as cartridges which are freely attachable to and detachable from the support frame 40. The engine controller 10 controls the developing unit 4. The developing unit 4 is driven into rotations based on a control instruction from the engine controller 10. When the developers 4Y, 4C, 4M and 4K are selectively positioned at a predetermined developing position which abuts on the photosensitive member 22 or is away a predetermined gap from the photosensitive member 22, toner of the color corresponding to the selected developer is supplied onto the surface of the photosensitive member 22 from a developing roller 44 disposed to the selected developer which carries toner of this color and has been applied with the predetermined developing bias. As a result, the electrostatic latent image on the photosensitive member 22 is visualized in the selected toner color.

The developers 4Y, 4C, 4M and 4K are provided with non-volatile memories 91 through 94, respectively, each memory storing data related to the respective developer. The developers are further provided with wireless communication devices 49Y, 49C, 49M, 49K, respectively. Whenever necessary, these communication devices selectively perform non-contact data communications with a wireless communication device 109 disposed in the apparatus body. Thus, data transmission/reception via an interface 105 is carried out between the CPU 101 and each of the memories 91 through 94, so that the CPU can manage a variety of information items, such as a consumable article, related to the developer of interest.

A toner image developed by the developer unit 4 in the manner above is primarily transferred onto an intermediate transfer belt 71 of a transfer unit 7 in a primary transfer region TR1. The transfer unit 7 comprises the intermediate transfer belt 71 which runs across a plurality of rollers 72 through 75, and a driver (not shown) which drives a roller 73 into rotations to thereby rotate the intermediate transfer belt 71 along a predetermined rotation direction D2. For transfer of a color image on the sheet S, toner images in the respective colors on the photosensitive member 22 are superposed one atop the other on the intermediate transfer belt 71, thereby forming a color image. Further, on the sheet S unloaded from a cassette 8 one at a time and transported to a secondary transfer region TR2 along a transportation path F, the color image is secondarily transferred.

At this stage, for the purpose of correctly transferring the image held by the intermediate transfer belt 71 onto the sheet S at a predetermined position, the timing of feeding the sheet S into the secondary transfer region TR2 is managed. To be more specific, there is a gate roller 81 disposed in front of the secondary transfer region TR2 on the transportation path F. As the gate roller 81 rotates in synchronization to the timing of rotations of the intermediate transfer belt 71, the sheet S is fed into the secondary transfer region TR2 at predetermined timing.

Further, the sheet S now bearing the color image is transported to a discharge tray 89, which is disposed to a top surface of the main section of the apparatus, through a fixing unit 9, a pre-discharge roller 82 and a discharge roller 83. Meanwhile, when images are to be formed on the both surfaces of the sheet S, the discharge roller 83 starts rotating in the reverse direction upon arrival of the rear end of the sheet S, which carries the image on its one surface as described above, at a reversing position PR located behind the pre-discharge roller 82, thereby transporting the sheet S in the arrow direction D3 along a reverse transportation path FR. While the sheet S is returned back to the transportation path F again before arriving at the gate roller 81, the surface of the sheet S which abuts on the intermediate transfer belt 71 in the secondary transfer region TR2 and is to receive a transferred image is at this stage opposite to the surface which already bears the image. In this fashion, it is possible to form images on the both surfaces of the sheet S.

As shown in FIG. 2, the apparatus comprises a display 12 which is controlled by a CPU 111 of the main controller 11. The display 12 is formed by a liquid crystal display for instance, and shows predetermined messages which are indicative of operation guidance for a user, a progress in the image forming operation, abnormality in the apparatus, the timing of exchanging any one of the units, etc.

In FIG. 2, denoted at 113 is an image memory which is disposed to the main controller 11, so as to store an image which is fed from an external apparatus such as a host computer via an interface 112. Denoted at 106 is a ROM which stores a calculation program executed by the CPU 101, control data for control of the engine part EG, etc. Denoted at 107 is a memory (RAM) which temporarily stores a calculation result derived by the CPU 101, other data, etc.

Further, there is a cleaner 76 in the vicinity of the roller 75. The cleaner 76 can be attached to and detached from the intermediate transfer belt 71 driven by an electromagnetic clutch not shown. When abutting on the intermediate transfer belt 71 as needed, the cleaner 76 scrapes off the toner remaining on the intermediate transfer belt 71 and the toner which constitutes the patch image.

Furthermore, a density sensor 60 is disposed in the vicinity of the roller 75. The density sensor 60 confronts a surface of the intermediate transfer belt 71 so as to measure, as needed, the density of the toner image formed on an outside surface of the intermediate transfer belt 71. Based on the measurement results, the apparatus adjusts the operating conditions of the individual parts thereof, the operating conditions affecting the image quality. The operating conditions include, for example, a developing bias applied to each developer, the intensity of the light beam L and the like.

The density sensor 60 employs, for example, a reflective photosensor for outputting a signal corresponding to an image density of a region of a given area defined on the intermediate transfer belt 71. The CPU 101 is adapted to detect image densities of individual parts of the toner image on the intermediate transfer belt 71 by periodically sampling the output signals from the density sensor 60 as moving the intermediate transfer belt 71.

Although capable of forming a full-color image, the image forming apparatus having the structure can serve also as an apparatus dedicated to monochrome printing which forms only monochrome images if that is a user's wish. In other words, when only one developer or two or more developers of the same toner color, instead of the four developers for the toner colors Y, M, C and K, are mounted to the rotary developing unit 4, this apparatus is capable of forming an image in this toner color. Noting this, rather than distinguishing the four developers by the toner colors, the four developers will now be denoted at 4a, 4b, 4c and 4d in the order of their use. The developers are used in turn along the direction of rotations D4 of the rotary developing unit 4, and when needed, the developer at a position toward the upstream side takes over the developer which is currently used. In this manner, switching of the developers during the image forming operation is attained only by rotating the rotary developing unit 4 by 90 degrees along its direction of rotations. Which developer should be used first needs be determined in advance. It is the developer 4a that is used first in the example below, which is not limiting.

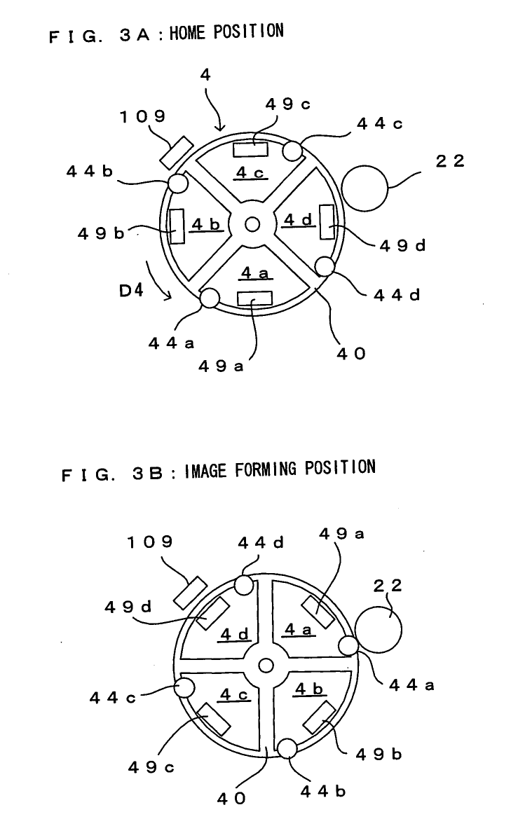

FIGS. 3A and 3B are drawings which show stop positions for the rotary developing unit. The rotary developing unit 4 is structured so that it can stop at a home position shown in FIG. 3A and an image forming position shown in FIG. 3B. The image forming position in FIG. 3B is one example: In reality, there are four image forming positions which are apart by 90 degrees from each other for the four developers. The home position is a stand-by position for the rotary developing unit 4 to stay when an image signal is not fed to the apparatus. At this home position, as shown in FIG. 3A, developing rollers 44a, 44b, 44c and 44d disposed to the respective developers are all away from the photosensitive member 22.

In the condition that the rotary developing unit 4 is in a halt at the image forming position, the developing roller disposed to one of the developers (which is the developer 4a in the example in FIG. 3B) is opposed against the photosensitive member 22. In this condition, it is possible to visualize an electrostatic latent image formed on the surface of the photosensitive member 22 with the toner which is held inside the developing roller 44a (image forming operation). In short, the position of the developer 4a in FIG. 3B corresponds to the “developing position” in the present invention.

Meanwhile, in the developer 4d which is at a position toward the downstream side relative to the developer 4a along the direction of rotations D4 of the rotary developing unit 4, a wireless communication device 49d disposed to the developer 4d comes opposed against a wireless communication device 109 on the main body of the apparatus. This permits a wireless communication access from the CPU 101 to the memory disposed to the developer 4d. Information regarding the status of use of this developer stored in the memory is updated in this condition (update operation). That is, the position of the developer 4d in FIG. 3B corresponds to the “access position” in the present invention.

As described above, in this image forming apparatus, the developing position and the access position are arranged so that when one developer mounted to the rotary developing unit 4 is positioned at the developing position, another developer is positioned at the access position. This makes it possible to update the memory while simultaneously executing the image forming operation, and therefore, shorten the processing time.

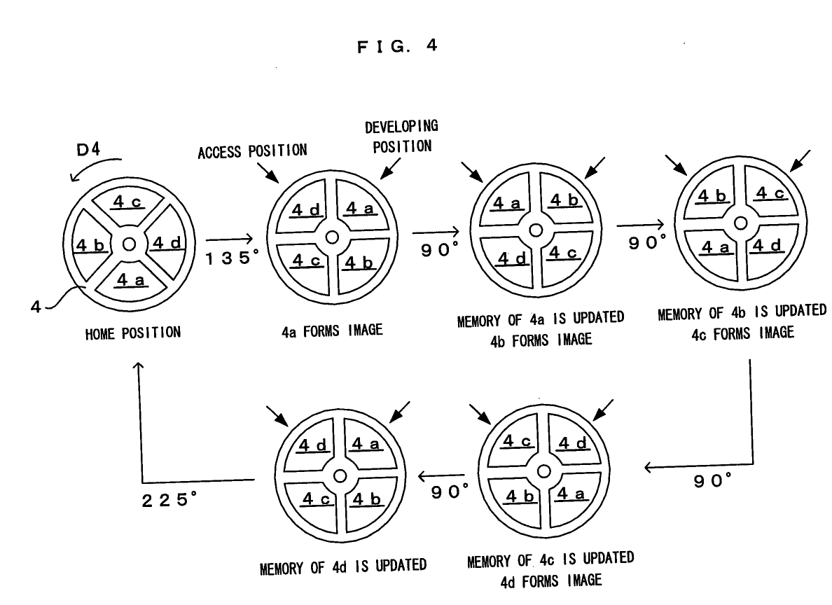

FIG. 4 is a drawing which shows an operation sequence for a full-color image forming operation. FIG. 4 is more particularly a schematic drawing which shows rotations of and stop positions for the developing unit 4 during the image forming operation. During the full-color image forming operation, the developing unit 4 first rotates 135 degrees from its home position. In this state, the developer 4a positioned at the developing position executes the image forming operation. Next, the developing unit 4 rotates 90 degrees. In this state, the developer 4a is positioned at the access position while the developer 4b is positioned at the developing position. The update operation for the developer 4a and the image forming operation by the developer 4b then proceed parallel to each other. In a similar fashion, the developing unit 4 rotates 90 degrees each time, thereby performing the update operation for the developer 4b and the image forming operation by the developer 4c in parallel and then the update operation for the developer 4c and the image forming operation by the developer 4d in parallel. The developing unit 4 further rotates 90 degrees, the developer 4d is positioned at the access position, the update operation is carried out, and the developing unit 4 returns back to its home position.

Since the developing position and the access position are apart by 90 degrees from each other as described above, during the full-color image forming operation which uses all developers, it is possible to execute the update operation with the developer which served the image forming operation earlier while simultaneously performing the image forming operation with the developer which is at a position toward the upstream side, and hence, shorten the time required for the entire processing.

A density controlling operation in this image forming apparatus will now be described. The density controlling operation is an operation in which a toner image is formed as a patch image, operation conditions (developing bias, exposure power, etc.) for the respective portions of the apparatus are adjusted based on the result of density detection on the toner image, and an image density is controlled to a target density. The density controlling operation is executed with at least one developer mounted to the support frame 40. It is also possible to execute the density controlling operation only for some of the developers which are mounted to the support frame 40.

When the density controlling operation is to be executed for all of the four developers, this may be attained following a similar operation sequence to that for the full-color image forming operation described above. However, when it is some of the four developers that need the density controlling operation, such an operation sequence may not always function effectively. A description will now be given on operation sequences for the density controlling operation corresponding to the arrangement of the four developers in the developing unit 4.

(First Operation Sequence)

A first operation sequence is an operation sequence which is suitable to where the developers that need the density controlling operation are mounted side by side in the developing unit 4. A description will now be given on an operation sequence for where the density controlling operation is executed on three or adjacent two developers which are mounted to the support frame 40. As described later, this operation sequence is applicable also to where the density controlling operation needs be executed on all of the four developers.

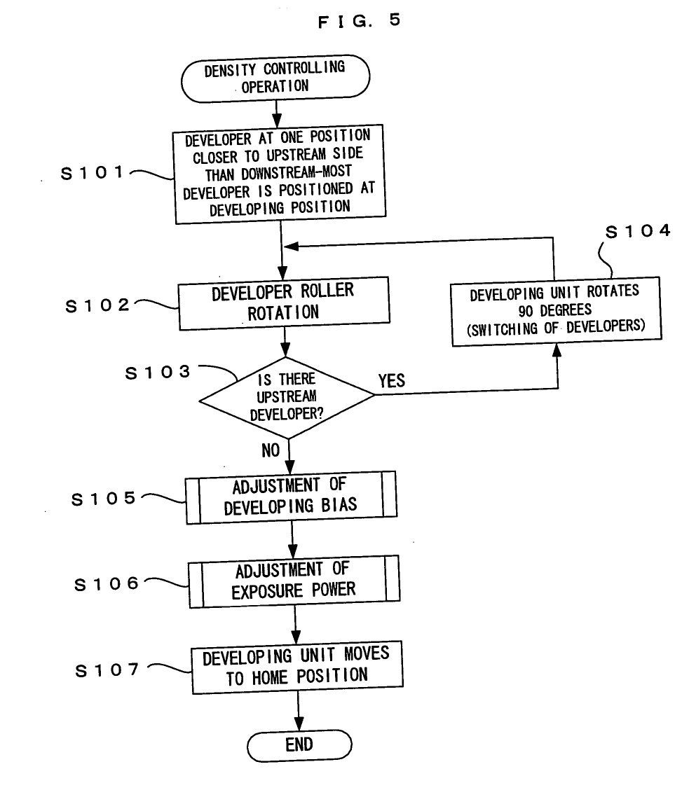

FIG. 5 is a flow chart which shows the density controlling operation for where the developers are adjacent to each other. During the density controlling operation, first, one of the series of developers requiring density control is moved to and positioned at the developing position (Step S101). This developer is the one which is adjacent to the downstream-most developer along the direction of rotations D4 of the developing unit 4 and which is also at one position toward the upstream side (upstream adjacent position) as viewed from the downstream-most developer along the direction of rotations D4 of the developing unit 4. It is the central developer 4b when the density controlling operation needs be executed on the three developers 4a, 4b and 4c for example. Meanwhile, when the density controlling operation needs be executed on the two adjacent developers 4a and 4b, it is the developer 4b which is on the upstream side. When the density controlling operation needs be executed on the four developers, the developer 4a is treated as the downstream-most developer and the developer 4b which is at the upstream adjacent position relative to the developer 4a is moved to the developing position.

The developing roller disposed to the developer which is at the developing position then rotates by a predetermined amount (Step S102). When a patch image is formed using old toner which has been left carried on the surface of the developing roller, the patch image may sometimes have an uneven density. As the developing roller rotates before forming an image however, supply of fresh toner to the surface of the developing roller suppresses creation of an uneven density. At this stage, for prevention of splashing of toner from the developing roller, it is desirable that no developing bias is applied or a potential different from that for formation of an image is provided to the developing roller.

Whether there is other developer that needs the density controlling operation at the upstream adjacent position relative to the developer currently located at the developing position is determined (Step S103), and when there is such a developer, the developing unit 4 rotates 90 degrees, thereby switching the developers (Step S104). The developing roller of the developer which is newly positioned at the developing position then rotates in a similar manner. For the other developers than the downstream-most developer among the developers which need the density controlling operation, the developing roller rotation is performed. As the developing unit 4 rotates in this manner, toner inside each developer is agitated and made uniform before a patch image is formed. The reason of omitting the developing roller rotation for the downstream-most developer will be described later.

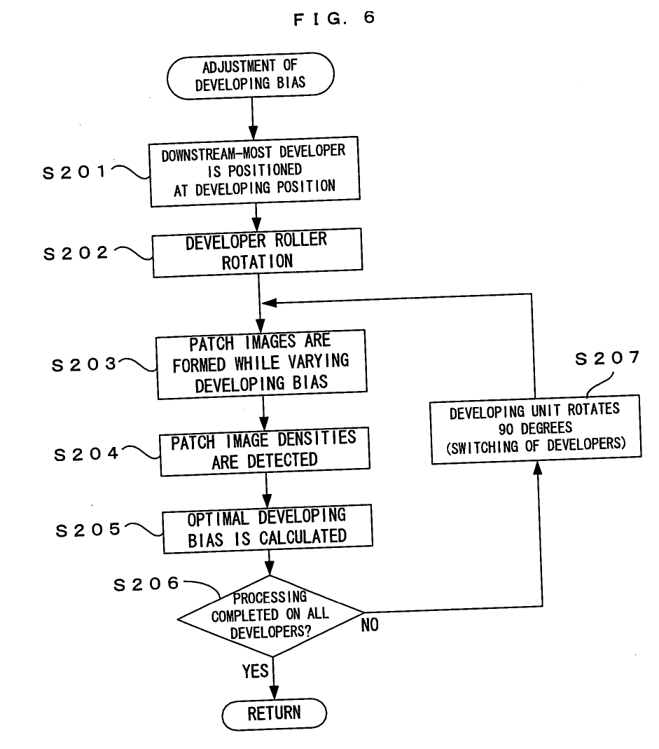

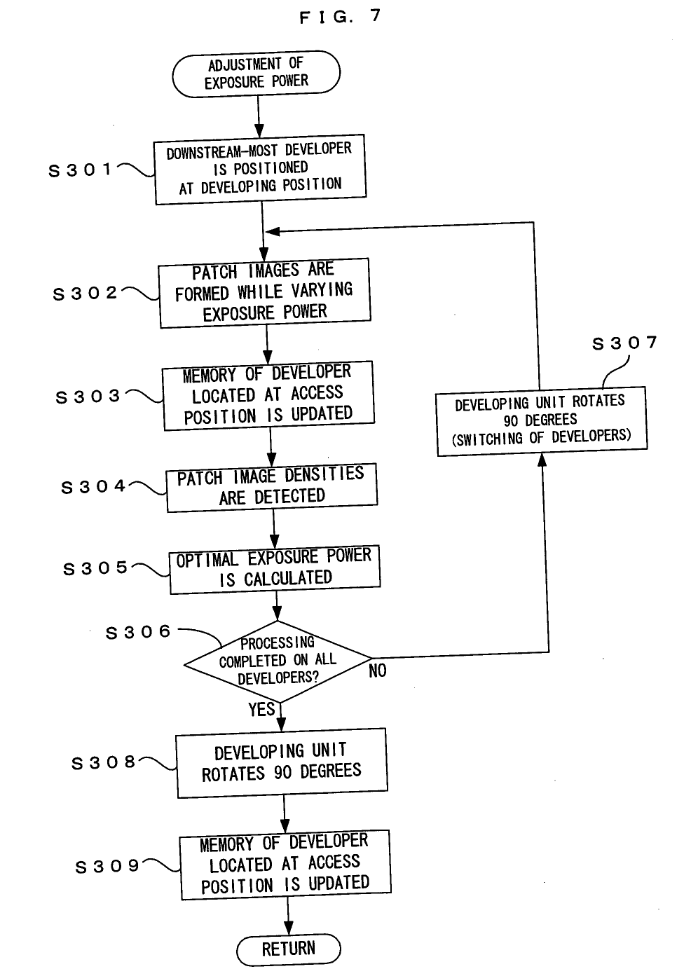

Following this, for the developers which need the density controlling operation, developing bias adjusting processing (Step S105 and FIG. 6) and exposure power adjusting processing (Step S106 and FIG. 7) are thereafter executed sequentially, to thereby calculate a developing bias value and an exposure power value for formation of an image with this developer. After this has completed, the developing unit 4 returns back to its home position and the processing ends (Step S107).

FIG. 6 is a flow chart which shows the developing bias adjusting processing. During this processing, first, of the developers which need the density controlling operation, the one which is at the downstream-most position along the direction of rotations D4 of the developing unit 4 is positioned at the developing position (Step 201). The developing roller rotation is performed for this developer (Step S202), and then patch images having a predetermined pattern (solid images for instance) are formed at various bias values while varying the developing bias over multiple levels (Step S203). The developing roller rotation is thus performed immediately before forming patch images for the developer which will be used first to form patch images, which reduces the number of times that the developing unit 4 must move and shortens the processing time. This is the reason why the developing roller rotation is not performed for the downstream-most developer during the operation shown in FIG. 5.

The density sensor 60 detects the densities of the patch images thus formed (Step S204), and based on the result of density detection on these patch images, an optimal value of the developing bias at which the density of an image will be a predetermined target density is calculated (Step S205). A method of calculating an optimal value of the developing bias is already known according to a number of conventional techniques, and therefore, will not be described in detail.

Whether the processing above has completed for all of the four developers which need the density controlling operation is determined (Step S206). When the density controlling operation has not been performed on some developers, after rotating the developing unit 4 by 90 degrees and switching the developers (Step S207), the processing above is repeated. The developing roller rotation already finished on the switched developers, and therefore, needs not performed again. This is followed by adjustment of the exposure power.

FIG. 7 is a flow chart which shows the exposure power adjusting processing. During this processing, the downstream-most developer along the direction of rotations D4 of the developing unit 4 is moved to the developing position once again (Step S301). Patch images having a predetermined pattern (halftone images for instance) are formed at various exposure power values while varying the power of the light beam L from the exposure unit 6 over multiple levels (Step S302).

In parallel with formation of the patch images, information stored in the memory disposed to the developer which is currently at the access position is updated (Step S303). When there is no developer at the access position at this point or it is the developer which does not need the density controlling operation that is positioned at the access position, memory update at this point (Step S303) may be omitted.

After formation of the patch images, as in the case of the developing bias adjusting processing, the density sensor 60 detects the densities of patch images (Step S304), and based on the result of density detection, optimal exposure power is calculated (Step S305). Until all developers which need the density controlling operation have been processed (Step S306), the processing above is repeated while switching the developers (Step S307), thereby calculating an optimal value of the exposure power for each developer. As the processing on all developers which need the density controlling operation completes, the developing unit 4 further rotates 90 degrees (Step S308). In consequence, the developer used at last to form the patch images, namely, the developer which is at the upstream-most position along the direction of rotations of the developing unit 4 among the group of the developers that need the density controlling operation is positioned at the access position. The memory of this developer is updated in this condition, and the processing ends (Step S309).

Execution of the density controlling operation designed as described above identifies the optimal developing bias and the optimal exposure power for each developer. As thus calculated optimal values are applied, images having the predetermined target density are formed through the image forming operation that follows. During the density controlling operation, patch images are formed using the developers positioned at the developing position in turn, starting with the downstream-most developer along the direction of rotations of the developing unit 4 among the group of the developers that need the density controlling operation. Hence, as the developing unit 4 merely rotates 90 degrees every time patch images are formed, all developers that need the density controlling operation are positioned at the access position in turn, which is the same as the operation sequence for the full-color image forming operation described earlier. It is thus possible to switch the developers in a short period of time and complete the density controlling operation in a short period of time.

In an attempt merely to reduce the number of times that the developers are switched, developing bias adjustment and exposure power adjustment may be carried out consecutively on one developer. However, this embodiment does not practice this. The reason is as described below. Patch images for exposure power adjustment are preferably formed with the developing bias set to the optimal developing bias value, and to this end, the optimal value of the developing bias must be already known by the time that patch images for exposure power adjustment are formed. It takes a certain period of processing time to form patch images, detect the densities of the patch images and calculate the optimal developing bias based on the result of density detection. Until this processing has finished, formation of patch images for exposure power adjustment must wait. Hence, consecutive execution of the developing bias adjusting processing and the exposure power adjusting processing does not necessarily shorten the total processing time. Noting this, this embodiment requires executing the developing bias adjusting processing for other developer between the developing bias adjusting processing and the exposure power adjusting processing for one developer, thereby avoiding unnecessary waiting time, and demands use of an operation sequence which minimizes the time to switch the developers, thereby completing the processing in a short period of time.

Further, during the exposure power adjusting processing, memory update is performed to update information stored in the memory which is disposed to the developer which has finished forming patch images and moved to the access position from the developing position. In this embodiment, the memory of each developer stores information which includes at least the remaining toner amount in this developer and the total operation time of the developing roller which is a parameter indicating the extent to which the developer and the toner inside have deteriorated. Since these values change after execution of the density controlling operation, the most recent values are stored in the memory for appropriate management of the life of the developer. Alternatively, the optimal developing bias and the optimal exposure power calculated through the developing bias adjusting processing and the exposure power adjusting processing may be stored. The memories are not updated after execution of the developing bias adjusting processing because the developing bias adjusting processing will be immediately followed by the exposure power adjusting processing after which the memories will have to be updated.

The developers form patch images, starting with the downstream-most developer along the direction of rotations of the developing unit 4, and the processing ends with the upstream-most developer. Hence, as one developer which has finished forming patch images is moved to the access position from the developing position, the developer which is supposed to form patch images next will inevitably move to the developing position. This minimizes the amount by which and the number of times for which the developing unit 4 must rotate to sequentially move the developers to the developing position and the access position, and shortens the processing time. Further, since it is possible to update the memory of the developer which is at the access position while simultaneously forming patch images using the developer which is at the developing position, the processing efficiency of the density controlling operation is even better.

The developer used lastly to form patch images needs be then moved to the access position so that information held in its memory will be updated. In this embodiment, since the access position is a position which is 90 degrees downstream relative to the developing position along the direction of rotations D4 of the developing unit 4, the amount by which the developing unit 4 must rotate is only 90 degrees. since the first developer starts forming patch images until updating of the memory of the last developer ends. This not only shortens the time required for switching, but simplifies control of rotations of the developing unit 4 as well.

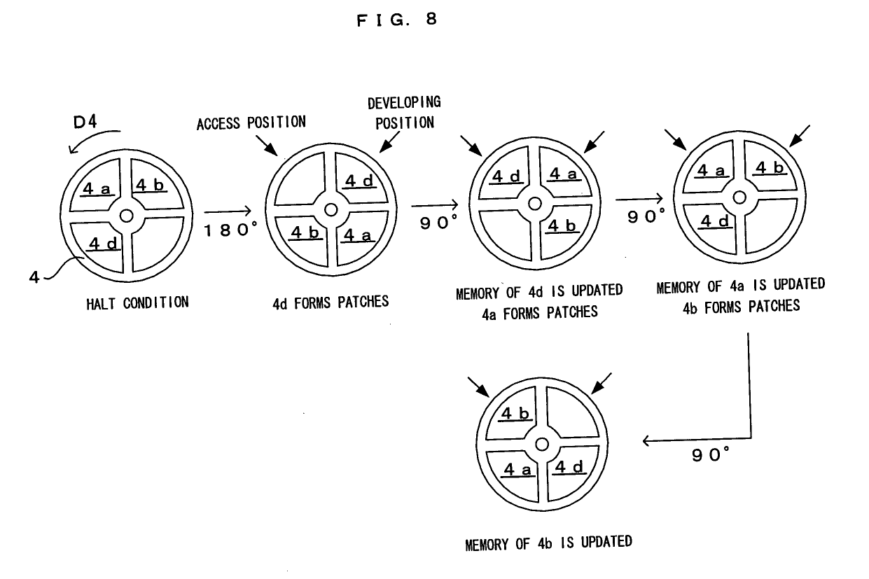

FIG. 8 is a drawing which shows how the developing unit moves during the density controlling operation on three developers. Shown in FIG. 8 and FIGS. 9 and 10 will be described later is rotations of the developing unit 4 since the start of the exposure power adjusting processing until the end of the exposure power adjusting processing. The example in FIG. 8 is the density controlling operation performed on the three developers 4a, 4b and 4d. Although the order of use of the developers according to the operation sequence for the full-color image forming operation should be 4a, 4b and 4d in this example, during the density controlling operation in this embodiment, since the developers are used in turn starting with the downstream developer along the direction of rotations D4 of the developing unit 4, the order of use of the developers is 4d, 4a and 4b.

As shown in FIG. 8, at the start of the exposure power adjusting processing, the developing unit 4 is in a halt with the developer 4b, which was used lastly to form a patch image, staying at the developing position. To move the downstream-most developer 4d to the developing position from this state, the developing unit 4 rotates 180 degrees. After the developer 4d has formed patch images in this condition, while rotating the developing unit 4 by 90 degrees each time, the memory of the earlier developer is updated and the next developer forms patch images in parallel for each such 90-degree rotation. In addition, also after the last (upstream-most) developer 4b has formed patch images, the developing unit 4 further rotates 90 degrees, the developer 4b is moved to the access position and the memory is updated.

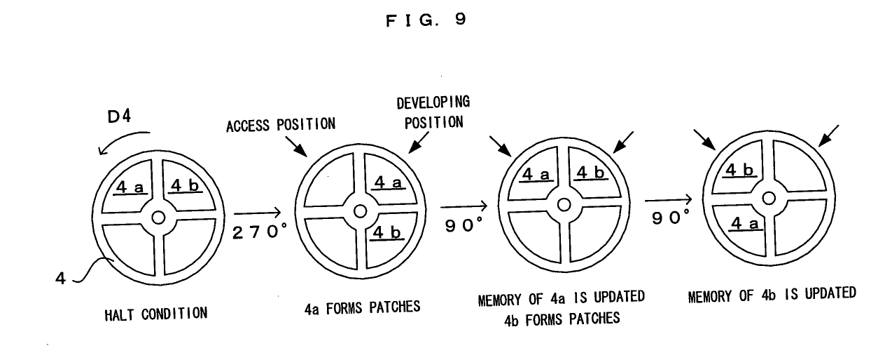

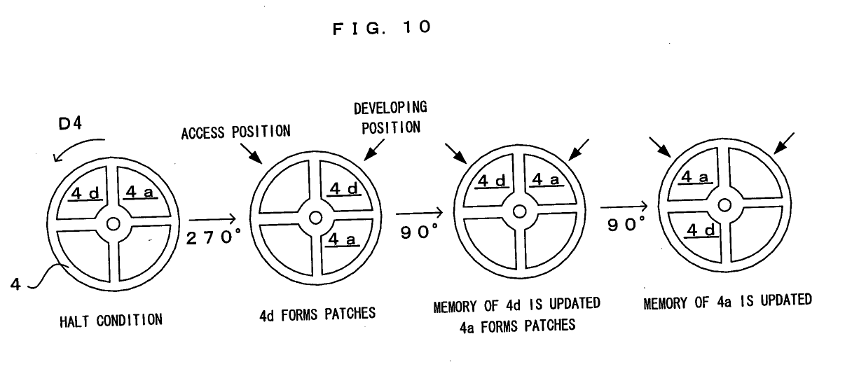

FIGS. 9 and 10 are drawings which show how the developing unit moves during the density controlling operation on two developers. FIG. 9 shows how the developing unit 4 moves during the density controlling operation performed on the two developers 4a and 4b, whereas FIG. 10 shows how the developing unit 4 moves during the density controlling operation performed on the two developers 4a and 4d. In the example in FIG. 9, since the developer 4a is on the downstream side and the developer 4b is on the upstream side, the order of use during the density controlling operation remains the same as that during the full-color image forming operation. That is, in this case, the developer 4a first forms patch images, the developer 4b is then moved to the developing position, and the content in the memory of the developer 4a is updated while the developer 4b forms patch images.

Meanwhile, in the example in FIG. 10, since the developer 4d is on the downstream side and the developer 4a is on the upstream side, during the density controlling operation, the developer 4d which is on the downstream side, not the developer 4a which will be used first during the full-color image forming operation, first forms patch images. In this manner, once the density controlling operation has been executed in the order which is based on the relationship between the positions of the developers relative to each other that need the density controlling operation, the developing unit 4 may rotate 90 degrees each time after that. In all of FIGS. 8 through 10, since the first developer starts forming patch images until updating of the memory of the last developer ends, the amount by which the developing unit 4 must rotate for switching of the developers is always 90 degrees. This shortens the time required for switching the developers and simplifies control of rotations of the developing unit 4.

In the embodiment described above, the engine controller 10 functions as the “controller” of the invention. The developers 4a, 4K, etc. each correspond to the “developer cartridge” of the invention. The density controlling operation in the embodiment above corresponds to the “adjusting operation” of the invention.

(2) Second Operation Sequence

A second operation sequence is an operation sequence which is suitable to where the developers demanding the density controlling operation include the developer which will be used first in the next image forming operation and the developers demanding the density controlling operation are not positioned adjacent to each other. In this operation sequence, the memory update operation is omitted for the developer which will be used first in the image forming operation, which shortens the processing time.

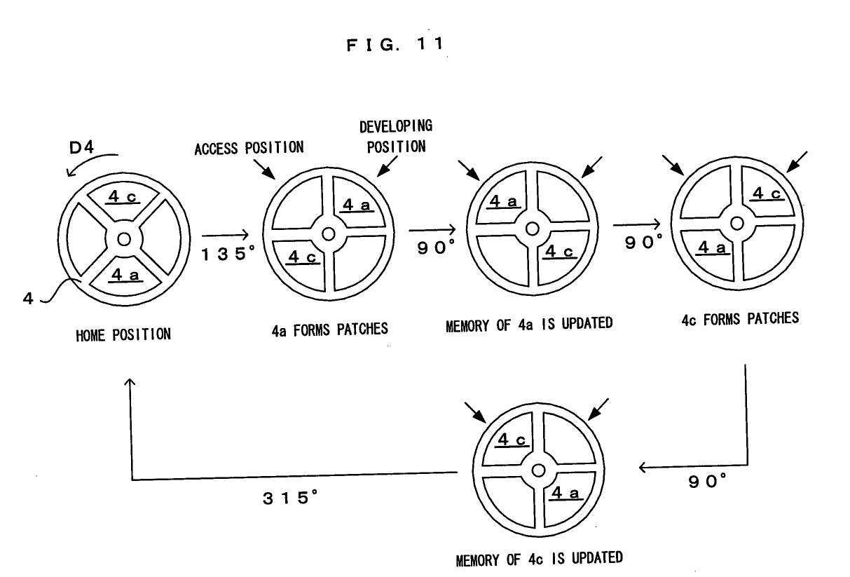

FIG. 11 is a drawing which shows a first example of a density controlling operation sequence on non-adjacent two developers. The density controlling operation on two developers 4a and 4c among the four developers will now be studied. Whether the other two developers are mounted does not matter. In this case, since it is not possible to position one developer at the developing position and the other developer at the access position at the same time, it is not possible to form patch images while simultaneously updating the memory.

Execution of the density controlling operation with this arrangement in a similar procedure to that for the density controlling operation on all developers, i.e., without applying the technical concept of the invention will result in a sequence as that shown in FIG. 11. In short, first, to move the developer 4a to the developing position, the rotary developing unit 4 rotates 135 degrees. In this condition, patch images are formed using the developer 4a. After forming the patch images, the rotary developing unit 4 further rotates 90 degrees, the developer 4a is moved to the access position and the content in the memory is updated. In a similar fashion, the developer 4c forms patch images and its memory is updated in this order as the rotary developing unit 4 rotates 90 degrees each time. The rotary developing unit 4 thereafter rotates 315 degrees and returns back to its home position. In this series of operations, the rotary developing unit 4 stops four times except for the time it stops at its home position, and the total amount by which the rotary developing unit 4 rotates is 720 degrees.

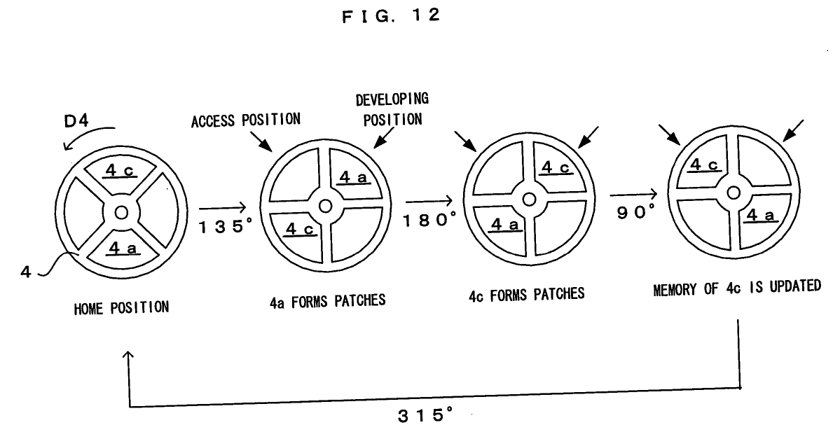

FIG. 12 is a drawing which shows a second example of the density controlling operation sequence on non-adjacent two developers. The technical concept of the invention is applied to this sequence. In this sequence, after patch images are formed using the developer 4a, the rotary developing unit 4 rotates 180 degrees, not 90 degrees. In other words, the memory update operation is omitted for the developer 4a. This stops the rotary developing unit 4 three times, one time less than in the example above, although the total amount by which the rotary developing unit 4 rotates is still 720 degrees as in the example above. Hence, the processing time required for the entire sequence is shorter than in the sequence according to the example above.

In the density controlling operation sequence to which the invention is applied, the memory update operation is omitted for the developer 4a, thereby shortening the processing time. This is because it is the developer 4a that is defined to be used first in the image forming operation and the status of use of this developer stored in the memory can be updated after the next image forming operation. That is, after execution of the image forming operation which follows the density controlling operation, the memory update operation is performed for the developer 4a, at which stage information regarding the status of use of this developer, including changes brought about by the density controlling operation, is updated. This achieves appropriate management of the life of the developer 4a.

(3) Third Operation Sequence

A third operation sequence is an operation sequence which corresponds to where the two developers demanding the density controlling operation are adjacent to each other and include the developer which will be used first in the next image forming operation and. This arrangement can be found in a situation that the developer which will be used first in the image forming operation is at the upstream adjacent position relative to the other developer, and a situation that the developer which will be used first in the image forming operation is at the downstream adjacent position relative to the other developer.

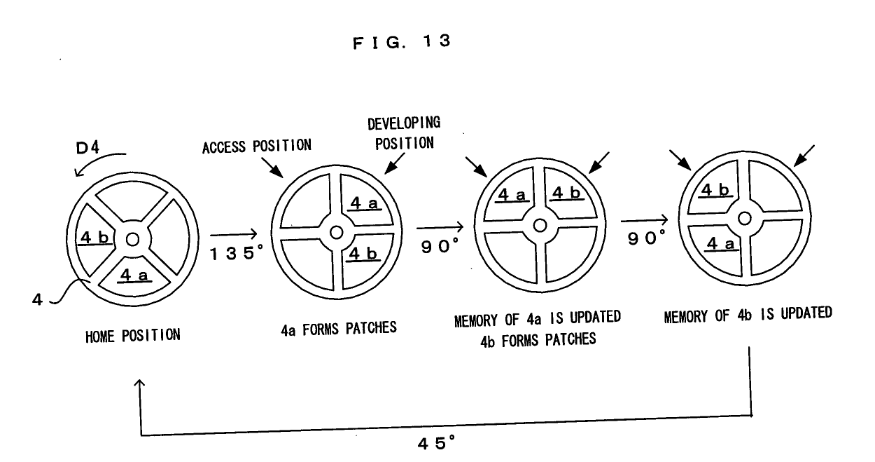

FIG. 13 is a drawing which shows a first example of the density controlling operation sequence on adjacent two developers. The density controlling operation on the developers 4a and 4b will now be studied. In this case, the developer 4a which will be used first in the image forming operation is on the downstream side relative to the developer 4b along the direction of rotations D4 of the rotary developing unit 4. As shown in FIG. 13, this permits forming patch images using the developer 4b simultaneously with the memory update operation, after the developer 4a formed patch images. The rotary developing unit 4 thus may stop merely three times and the time required for the density controlling operation is therefore relatively short.

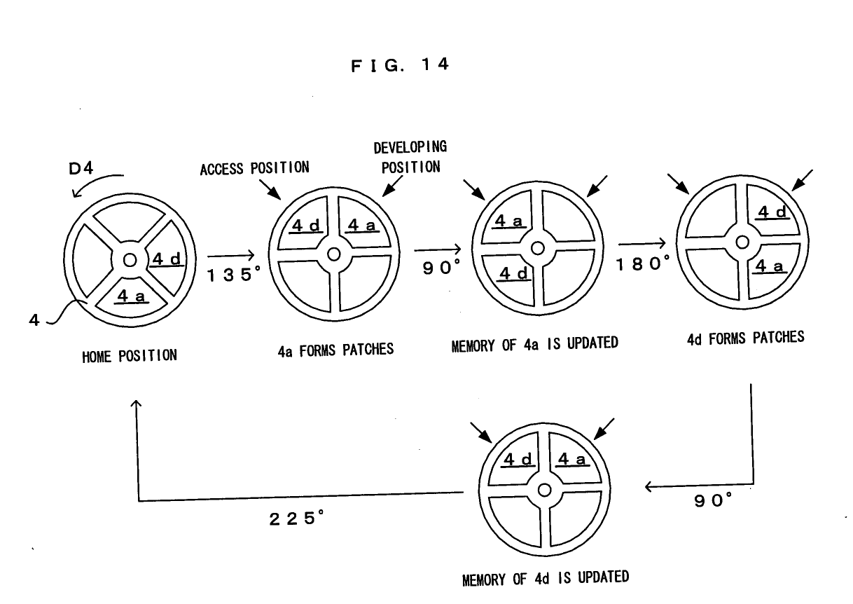

FIG. 14 is a drawing which shows a second example of the density controlling operation sequence on adjacent two developers. With this arrangement, the developer 4a which will be used first in the image forming operation is on the upstream side relative to the developer 4d along the direction of rotations D4 of the rotary developing unit 4. When the arrangement is such, patch image formation and execution of the memory update operation on each one of the two developers with the conventional technique will end up in stopping the rotary developing unit 4 four times, as shown in FIG. 14.

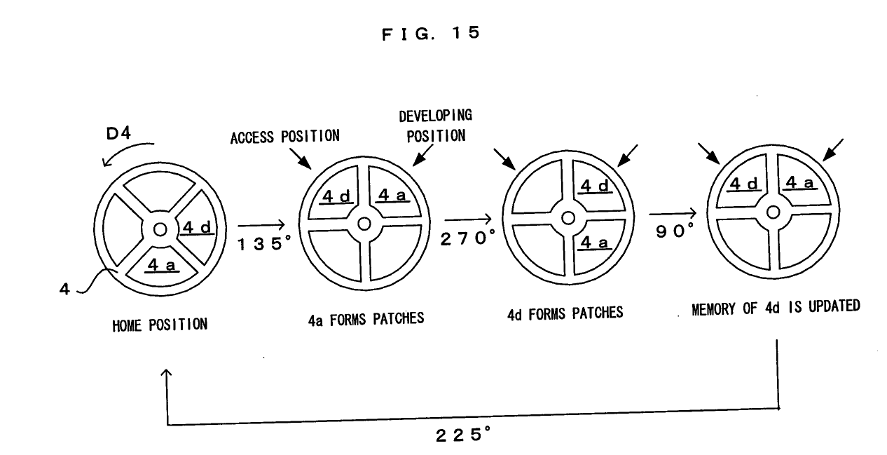

FIG. 15 is a drawing which shows a third example of the density controlling operation sequence on adjacent two developers. The technical concept of the invention is applied to this sequence, and the memory update operation for the developer 4a is omitted. This stops the rotary developing unit 4 three times, thereby shortening the time required for the density controlling operation than in the example in FIG. 14.

As described above, in the event that the density controlling operation needs be performed on two among the four developers which can be mounted to the rotary developing unit 4, when the relationship between the positions of the two developers is that the developer which will be used first in the image forming operation comes to the access position as the developer which will be used later in the image forming operation is positioned at the developing position, it is possible to update the memory of the developer which will be used first while simultaneously forming patch images using the developer which will be used later. On the contrary, when the developer which will be used first does not come to the access position as the developer which will be used later in the image forming operation is positioned at the developing position, patch image formation and the memory update operation can not be executed at the same time. Noting this, in this embodiment, for the developer which will be used first, the density controlling operation which does not accompany the memory update operation is executed. This reduces the number of times the rotary developing unit 4 stops and shortens the processing time.

The order of use of the developers in which the density controlling operation is executed is determined along the direction of rotations of the developing unit 4, which reduces the amount by which the rotary developing unit 4 rotates for switching the developers.

Further, in this embodiment, the access position is a position which is 90 degrees downstream relative to the developing position along the direction of rotations of the developing unit 4. Hence, while one developer at the developing position forms an image or a patch image, the memory update operation can be executed on the developer which has formed an image or a patch image immediately before this.

### Other Embodiments

Although different from the structure of the apparatus according to this embodiment, other structure that the access position is a position which is 180 degrees from the developing position will now be studied.

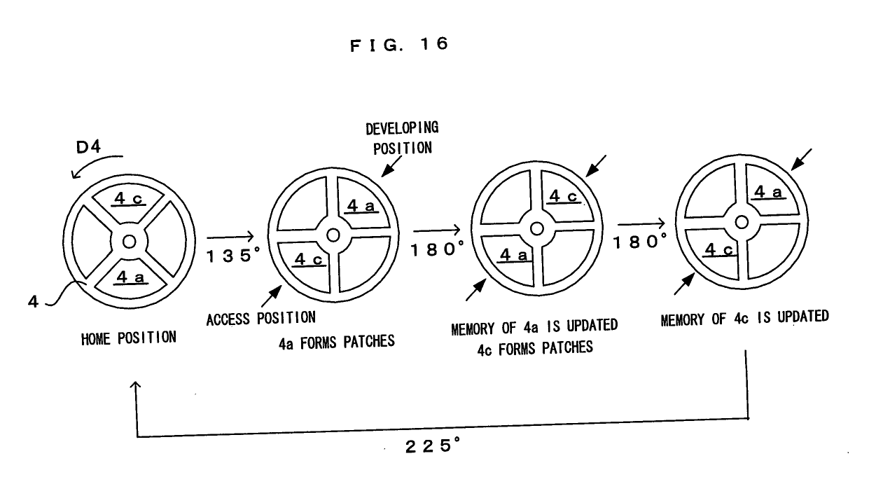

FIG. 16 is a drawing which shows one example of the density controlling operation sequence on non-adjacent two developers. With this arrangement, the developer 4a which will be used first can be positioned at the access position and the developer 4c which will be used later can be positioned at the developing position at the same time. Hence, while the rotary developing unit 4 stops three times, patch image formation and the memory update operation can not be executed for both of the two developers 4a and 4c.

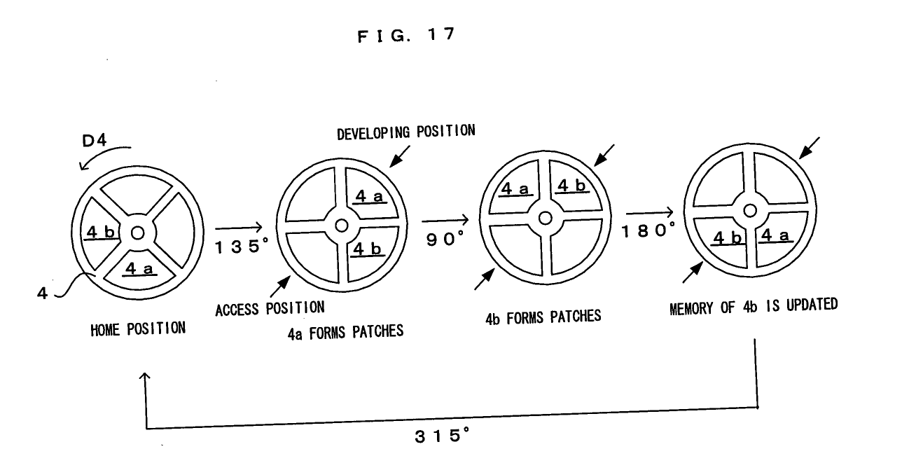

FIG. 17 is a drawing which shows one example of the density controlling operation sequence on adjacent two developers. As described earlier, in the event that the density controlling operation needs be performed on the developers 4a and 4b, when the gap between the developing position and the access position is 90 degrees, it is possible to perform patch image formation and the memory update operation for both of the two developers 4a and 4c while the rotary developing unit 4 stops three times. However, the rotary developing unit 4 must stop four times when the gap between the developing position and the access position is 180 degrees. When the positions are related to each other as such, as shown in FIG. 17, the memory update operation for the developer 4a may be omitted to thereby reduce the number of times the rotary developing unit 4 stops down to three times.

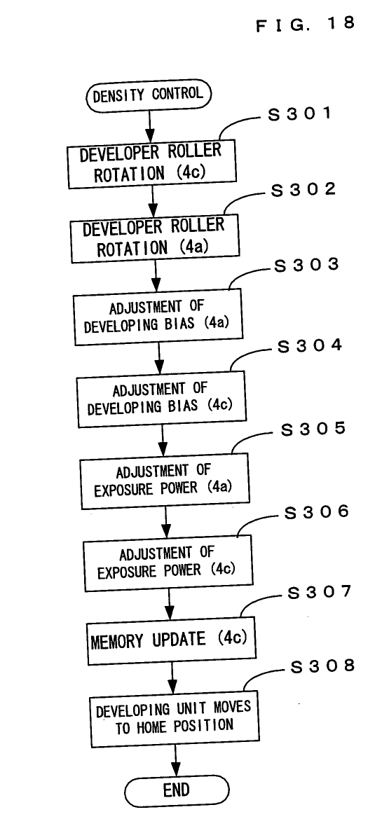

FIG. 18 is a flow chart of the density controlling operation sequence in this embodiment. The density controlling operation on the two developers 4a and 4c mounted at non-adjacent positions will now be described as an example. During this density controlling operation, from among the operation conditions for the apparatus, the developing bias and the exposure power are adjusted.

The actual density controlling operation is performed as the CPU 101 executes a program stored in the ROM 106 in the following manner. First, the rotary developing unit 4 rotates, thereby positioning the developers 4c and 4a at the developing position one after another, and the developing rollers 44c and 44a disposed to these developers rotate (Step S301, Step S302). This developing roller rotation is an operation that the developing roller positioned at the developing position rotates a few rounds, by which fresh toner is supplied to and a new toner layer is formed on the surface of the developing roller. The developing roller rotation for the developer 4c comes first, for the purpose of agitating toner inside the developer in advance by means of great rotations of the rotary developing unit 4.

Next, the developing bias is adjusted for the developers 4a and 4c in turn (Step S303, Step S304), and the exposure power is then adjusted for the developers 4a and 4c in turn (Step S305, Step S306). The developing bias and the exposure power are not adjusted consecutively for each developer, but the developers are switched between adjustment of the developing bias and that of the exposure power. This is to apply the developing bias which has been optimized through the developing bias adjusting operation to adjustment of the exposure power. It takes a certain period of time during the developing bias adjusting operation to detect the densities of the patch images which have been formed and calculate the optimal developing bias based on the result of density detection. Since adjustment of the exposure power can not be executed immediately after adjustment of the developing bias, during this period, the next developer may form patch images to thereby shorten the total processing time.

After the density controlling operation has been performed on the two developers in this manner, the developer 4c is moved to the access position and the memory update operation is executed (Step S307), and the developing unit 4 returns back to its home position (Step S308). As described earlier, the memory update operation for the developer 4a is executed after the developer 4a has finished the image forming operation. Information regarding the status of use of the developers to be stored in the memories may be for instance the number of toner dots formed using the developers, the amount of toner used, the amounts of rotations of the developing rollers, etc.

### MODIFIED EXAMPLES

The invention is not limited to the embodiments above, but may be modified in various manners in addition to the embodiments above, to the extent not deviating from the object of the invention. For example, while the embodiments above are directed to an image forming apparatus comprising the developing unit 4 to which up to four developers can be mounted, this is not limiting. The invention is applicable to an apparatus in which three or more developers can be mounted.

Further, although the developing rollers disposed to the developers rotate before forming patch images in the embodiments above, this is not indispensable to the invention. In addition, during the density controlling operation in the embodiments above, the developing bias and the exposure power are adjusted as parameters relevant to the operation conditions for the apparatus. However, various parameters of this type are known other than these two and there are a number of conventional density controlling techniques which use such parameters, and therefore, the invention is applicable to an apparatus utilizing these density controlling techniques.

Further, although the memories disposed to the developers communicate with the CPU 101 via wireless communication to write and read the memories in the embodiments above, the main apparatus section and the developers may be connected by connectors for wired communication to write and read the memories.

While the invention is equally applicable to a full-color image forming apparatus equipped with developers which hold toner of mutually different colors and a monochrome image forming apparatus equipped with developers which hold toner of a single color, the latter application brings about a particularly remarkable effect. This is because while developers for all toner colors are necessary to form a full-color image, it is possible in theory for a monochrome image forming apparatus to form an image as long as it comprises at least one developer and a monochrome image forming apparatus is likely to perform with only some of its developers mounted. Permitting the image forming operation in such a condition provides better convenience to users.

Further, although the embodiments above use the four toner colors of yellow (Y), cyan (C), magenta (M) and black (K), the number and the types of the toner colors are not limited to this. The invention is applicable also to an apparatus equipped with plural developers for the same toner color. The invention is not limited to a printer as that according to the embodiments above but is applicable to other image forming apparatus such as a copier machine and a facsimile machine.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. An image forming apparatus, comprising:
a rotary developing unit which is capable of freely rotating in a predetermined direction and accepts N (N is an integer equal to or larger than 3) developer cartridges, each of the developer cartridges comprising a memory unit which stores information regarding status of use of the developer cartridge; and
a controller which executes an image forming operation, during which a toner image is formed using a developer cartridge positioned at a predetermined developing position among developer cartridges which are mounted to the rotary developing unit, and an update operation during which the controller accesses the memory unit disposed to a developer cartridge positioned at a predetermined access position and updates content of the memory unit,
wherein the developing position and the access position are in such a relationship that one developer cartridge, which is located on an upstream side along the direction of rotations of the rotary developing unit among two developer cartridges mounted at two adjacent positions on the rotary developing unit, is positioned at the developing position, and that the other developer cartridge of the two developer cartridges is positioned at the access position,
the controller executes the image forming operation using one developer cartridge mounted to the rotary developing unit, thereby forming a toner image which serves as a patch image, and additionally executes, based on a detected density of the patch image, an adjusting operation of adjusting an operation condition which will be used when this developer cartridge will serve in the image forming operation, and
when the controller is to execute the adjusting operation on M (M is an integer equal to or larger than 2 but smaller than N) developer cartridges which are mounted adjacent to each other to the rotary developing unit, while switching the developer cartridges in a direction from a downstream-most developer cartridge among the M developer cartridges toward an upstream-most developer cartridge along the direction of rotations of the rotary developing unit, the controller positions the developer cartridges one by one at the developing position and makes the developer cartridges each form the patch image, and the controller executes the update operation on the developer cartridges which comes to the access position after forming the patch image.

2. The image forming apparatus of claim 1, wherein the controller makes the developer cartridge newly positioned at the developing position by switching of the developer cartridges form a patch image while simultaneously executing the update operation on the developer cartridge newly positioned at the access position by the switching of the developer cartridges.

3. The image forming apparatus of claim 1, wherein after forming the patch image using the upstream-most developer cartridge along the direction of rotations of the rotary developing unit among the M developer cartridges, the controller moves this developer cartridge to the access position and executes the update operation on this developer cartridge.

4. The image forming apparatus of claim 1, wherein the M developer cartridges hold toner of the same color.

5. An image forming apparatus, comprising:
a rotary developing unit which is capable of freely rotating in a predetermined direction and accepts three or more developer cartridges, each of the developer cartridges comprising a memory unit which stores information regarding status of use of the developer cartridge; and
a controller which executes an image forming operation, during which a toner image is formed using a developer cartridge positioned at a predetermined developing position among developer cartridges which are mounted to the rotary developing unit, and an update operation during which the controller accesses the memory unit disposed to a developer cartridge positioned at a predetermined access position and updates content of the memory unit,
wherein the developing position and the access position are in such a relationship that when one of the developer cartridges mounted to the rotary developing unit is positioned at the developing position, another developer cartridge is positioned at the access position,
the controller executes the image forming operation of forming a toner image which serves as a patch image, and additionally executes, based on the detected density of the patch image, an adjusting operation of adjusting an operation condition which will be applied for execution of the image forming operation, and
in the event that the controller is to execute the adjusting operation on two developer cartridges mounted to the rotary developing unit, when the two developer cartridges are positioned relative to each other such that a first developer cartridge out of the two developer cartridges which will be used first in next image forming operation is positioned at other position than the access position as a second developer cartridge out of the two developer cartridges comes to the developing position, the controller executes the update operation on the second developer cartridge after executing the adjusting operation, and on the first developer cartridge, executes the adjusting operation which does not accompany the update operation.

6. The image forming apparatus of claim 5, wherein the controller executes the adjusting operation on the first developer cartridge, the adjusting operation on the second developer cartridge and the update operation on the second developer cartridge in this order.

7. The image forming apparatus of claim 5, wherein the developing position and the access position are determined such that when one developer cartridge mounted to the rotary developing unit is positioned at the developing position, other developer cartridge which is on downstream side along the direction of rotations of the rotary developing unit and mounted to the rotary developing unit at an adjacent position to one developer cartridge comes to the access position.

8. The image forming apparatus of claim 5, wherein when the first developer cartridge is to execute the image forming operation after execution of the adjusting operation, the controller executes the update operation on the first developer cartridge after this image forming operation.

9. An adjustment method for an image forming apparatus which comprises a rotary developing unit which is capable of freely rotating in a predetermined direction and accepts N (N is an integer equal to or larger than 3) developer cartridges, each of the developer cartridges comprising a memory unit which stores information regarding status of use of the developer cartridge, for each one of M (M is an integer equal to or larger than 2 but smaller than N) developer cartridges which are mounted adjacent to each other to the rotary developing unit, comprising:
a patch image formation step at which a developer cartridge is positioned at a predetermined developing position, and using the developer cartridge, a toner image which serves as a patch image is formed;
an adjustment step at which a density of the patch image is detected, and based on a result, an operation condition which will be applied to form a toner image using the developer cartridge is adjusted; and
an update step at which the memory unit disposed to the developer cartridge is accessed and content of the memory unit is updated,
wherein the patch image formation step is executed while switching the developer cartridges in a direction from a downstream-most developer cartridge among the M developer cartridges toward an upstream-most developer cartridge along the direction of rotations of the rotary developing unit, and
the update step is executed on one developer cartridge which is on the downstream side and adjacent to other developer cartridge which is positioned at the developing position along the direction of rotations of the rotary developing unit.

10. An adjustment method for an image forming apparatus which comprises a rotary developing unit, which is capable of freely rotating in a predetermined direction and accepts three or more developer cartridges, each of the developer cartridges comprising a memory unit which stores information regarding status of use of the developer cartridge, and which is capable of executing an image forming operation, during which a toner image is formed using a developer cartridge positioned at a predetermined developing position among developer cartridges which are mounted to the rotary developing unit, and an update operation during which the memory unit disposed to a developer cartridge positioned at a predetermined access position is accessed and content of the memory unit is updated, comprising:
a step of forming a toner image which serves as a patch image; and
a step of adjusting an operation condition which will be applied for execution of the image forming operation based on a detected density of the patch image,
wherein in the event that the adjusting operation needs be executed on two developer cartridges mounted to the rotary developing unit, when the two developer cartridges are positioned relative to each other such that a first developer cartridge out of the two developer cartridges which will be used first in next image forming operation gets positioned at other position than the access position as a second developer cartridge out of the two developer cartridges comes to the developing position, the update operation is executed on the second developer cartridge after adjusting the operation condition, and on the first developer cartridge, the operation condition is adjusted without execution of the update operation.
